(19) United States
(12) Patent Application Publication
(10) Pub. No.: US 2025/0058821 A1
(43) Pub. Date: Feb. 20, 2025

(54) Method for Operating a Steering System

(71) Applicant: Robert Bosch GmbH, Stuttgart (DE)

(72) Inventors: Michael Friedel, Ruppertshofen (DE); Martin Zimmermann, Schwaebisch Gmuend (DE)

(21) Appl. No.: 18/728,816

(22) PCT Filed: Dec. 19, 2022
(86) PCT No.: PCT/EP2022/086570

§ 371 Date: Jul. 12, 2024

(30) Foreign Application Priority Data
Jan. 13, 2022 (DE) 10 2022 200 268.7

(51) Int. Cl. B62D 5/04

(52) U.S. Cl. CPC B62D 5/0481; B62D 5/046

(57) ABSTRACT

A method for operating a steering system of a vehicle, wherein the steering system comprises a steering mechanism and at least one electric motor cooperating with the steering mechanism, and wherein a stiffness of a steering assembly of the steering mechanism and/or play in the steering mechanism is determined includes determining the stiffness of the steering assembly and/or play in the steering mechanism. The steering mechanism is brought into a defined test position and/or blocked in the test position and the electric motor is actuated with an excitation signal, and the stiffness of the steering assembly and/or play in the steering mechanism is determined in that, during the actuation of the electric motor with the excitation signal, a motor torque of the electric motor and a rotor orientation angle of the electric motor is monitored and a change in the motor torque is evaluated according to the rotor orientation angle.

### PRIOR ART

The invention is based upon a method for operating a steering system according to the preamble of claim 1. In addition, the invention relates to a computing unit for performing such a method, a steering system with such a computing unit and a vehicle with such a steering system.

To date, only a very small proportion of the mechanical anomalies that can occur during the operation of a vehicle or steering system can be automatically detected. As such, it is up to the driver to detect the majority of anomalies. However, as the trend towards automated and/or autonomous driving increases, manual fault detection of this kind is becoming less and less viable. Furthermore, vehicles with steer-by-wire steering systems which do not require a direct mechanical connection between a steering wheel and the steered vehicle wheels are also known. Due to the mechanical decoupling, mechanical anomalies that can occur in a steering gear, for example, are not directly fed back to the steering wheel, which also makes manual detection more difficult.

For this reason, DE 10 2019 212 618 A1 proposes a method for automatically determining the stiffness of at least one steering assembly and/or the amount of free play in a steering mechanism. A wheel position is thus determined by means of a monitoring device using a wheel position sensor and related to an input variable specified by an electric motor. In this case, however, the steering mechanism is not brought into a defined test position and/or is blocked in the test position. In addition, this type of procedure requires the wheel position to be determined, which can be disadvantageous under certain circumstances.

In addition, DE 10 2018 112 812 A1 describes a method for the automated determination of free play in a steering mechanism, in which excitation takes place via a motor torque with different frequencies. Even in this case, however, the steering mechanism is not brought into a defined test position and/or is blocked in the test position. As a result, the excitation can only take place for small torques, as otherwise the entire steering system is moved. Accordingly, the free play in this case can only be determined in a low-load range.

The task of the invention is, in particular, to provide a method for operating a steering system with improved properties in terms of efficiency. This object is achieved by the features of claims 1, 17, 18, and 19, while advantageous configurations and further developments of the invention can be gathered from the dependent claims.

### DISCLOSURE OF THE INVENTION

The invention relates to a method, in particular a computer-implemented method, for operating a steering system of a vehicle, wherein the steering system comprises a steering mechanism and at least one electric motor cooperating with the steering mechanism, and wherein a stiffness of at least one steering assembly of the steering mechanism and/or play in the steering mechanism is determined, in particular automatically and/or in an automated manner.

It is proposed that to determine the stiffness of the at least one steering assembly and/or play in the steering mechanism, the steering mechanism is brought into a defined test position and/or blocked in the test position and the electric motor is actuated with an excitation signal, and wherein the stiffness of the at least one steering assembly and/or play in the steering mechanic is determined in that, during the actuation of the electric motor with the excitation signal, a motor torque of the electric motor and a rotor orientation angle of the electric motor is monitored and a change in the motor torque is evaluated according to the rotor orientation angle. In the present case, the steering mechanism is thus positioned and/or blocked in the test position in a first process step, in a second process step the steering system is excited by actuating the electric motor with the excitation signal while the steering mechanism is in the test position, and in a third process step a system response of the steering system to the excitation signal is determined and evaluated using the motor torque and the rotor orientation angle. In this context, the steering mechanism can be positioned in the test position manually, for example by an occupant and/or driver of the vehicle, or automatically and/or automatically by actuating the electric motor accordingly. In addition, the three above-mentioned process steps for determining the stiffness of the at least one steering assembly and/or play in the steering mechanism can be repeated in a fourth process step for at least one further test position that differs from the test position. In particular, the repetition can concern the same steering assembly or a further steering assembly that differs from the steering assembly. This configuration can improve efficiency, in particular test efficiency, performance efficiency, component efficiency, energy efficiency and/or cost efficiency. In addition, the operational safety of the steering system in particular can be increased. Moreover, the stiffness of the at least one steering assembly and/or play in the steering mechanism can be advantageously determined in both a low-load range and a high-load range.

In the present case, the steering system can be designed as a conventional steering system, in particular as an electric power steering system, and can comprise a mechanical hand grip. Alternatively, however, the steering system can be designed as a steer-by-wire steering system, in which a steering input is advantageously transmitted to the vehicle wheels purely electrically. The steering mechanism further comprises the at least one steering assembly and preferably several, in particular different, steering assemblies. The steering mechanism can, for example, comprise a first steering assembly designed as a servo train, a second steering assembly designed as a sensor train and/or a third steering assembly designed as a vehicle axle and/or part of a vehicle axle. In this context, the servo train corresponds in particular to a steering gear of the steering system, while the sensor train corresponds to a steering shaft and/or a steering column of the steering system. Furthermore, the steering system advantageously comprises a steering actuator, in particular an electric and/or electronic steering actuator, which has the electric motor. In this context, a “steering actuator” should primarily be understood as an actuator unit which is preferably coupled to the servo train and is intended to transmit a steering torque to the steering mechanism, in particular the servo train, by means of the electric motor in order to influence the direction of travel of the vehicle. Preferably, the steering actuator is designed to provide a steering torque using the electric motor to support a manual torque applied to a steering handle of the steering system and/or a steering torque for automatic and/or autonomous control of a direction of travel of the vehicle. In addition, the steering system can comprise a locking mechanism, advantageously mechanical, which is provided for blocking, in particular for fixing and/or locking, the steering mechanism in the test position. To this end, the locking mechanism can in particular comprise at least one electrical and/or mechanical lock, for example a steering lock in the region of the steering handle, a locking unit in the region of the steering shaft, in particular an input shaft of the steering shaft, and/or a wheel lock in the region of a vehicle wheel of the vehicle.

Furthermore, the vehicle comprises at least one computing unit, which is intended to perform the method for operating the steering system. The term “computing unit” is mainly understood to mean an electrical and/or electronic unit having an information input, information processing, and an information output. Advantageously, the computing unit also has at least one processor, at least one operating memory, at least one input means and/or output means, at least one operating program, at least one control routine, at least one regulation routine, at least one calculation routine and/or at least one evaluation routine. In particular, the computing unit is provided for determining the stiffness of the at least one steering assembly and/or play in the steering mechanism. The computing unit is also provided for actuating the electric motor. Furthermore, the computing unit can also be provided for actuating the locking mechanism. In the present case, the computing unit is provided at least for actuating the electric motor with the excitation signal, monitoring a motor torque of the electric motor and a rotor orientation angle of the electric motor during the actuating of the electric motor with the excitation signal and evaluating a change in the motor torque according to the rotor orientation angle. In addition, the computing unit can be provided, in particular by actuating the electric motor, to bring the steering mechanism into a defined test position and/or to block it in the test position by actuating the locking mechanism. Preferably, the computing unit is integrated into a control unit of the vehicle and/or a control unit of the steering system, in particular in the form of a steering control unit. The term “provided” is understood in particular as meaning specifically programmed, designed and/or equipped. In particular, the phrase “an object being provided for a specific function” is intended to mean that the object fulfills and/or performs this specific function in at least one application state and/or operating state.

It is also preferably proposed that the stiffness of the at least one steering mechanism and/or play in the steering mechanism is determined by means of a derivative of the motor torque according to the rotor orientation angle or a difference quotient of the motor torque and rotor orientation angle, i.e. using a rate of change of the motor torque as a function of the rotor orientation angle, which makes it particularly easy to monitor a change in the motor torque according to the rotor orientation angle.

In a further configuration, it is proposed that, in order to determine the stiffness of the at least one steering assembly and/or play in the steering mechanism, the change in the motor torque according to the rotor orientation angle is compared with a reference value. This in particular makes it possible to provide an advantageously simple evaluation algorithm.

Moreover, it is proposed that linearization, advantageously for different load levels, is used when determining the stiffness of the at least one steering assembly and/or play in the steering mechanism. In this context, it must be taken into account that the stiffness to be determined and/or play to be determined normally has a non-linear relationship. In the present case, however, it was recognized that even when using a corresponding linearization, relatively precise and exact statements about the stiffness and/or play are possible and at the same time a computational effort can be greatly reduced.

If a current temperature is considered when determining the stiffness of the at least one steering assembly and/or play in the steering mechanism, an evaluation result can be further specified. Advantageously, the temperature is recorded in the region of the steering mechanism, for example via an additional temperature sensor, or preferably directly in the region of the electric motor. In the latter case, a temperature sensor integrated into the steering actuator can advantageously be used to determine the current temperature, whereby additional costs can be advantageously minimized.

According to a particularly preferred configuration, it is proposed that the electric motor is actuated by means of the excitation signal such that a quasi-static excitation is achieved, wherein the motor torque is continuously increased up to a, in particular defined and/or definable, maximum motor torque, for example +5 Nm. This makes it particularly easy to control the excitation of the steering system. In this case, the electric motor is preferably actuated by means of a ramped signal so that the excitation signal is increased continuously and/or ramped. In this case, the motor torque could be increased directly by adjusting the motor torque. Preferably, however, the motor torque is increased by adjusting the rotor orientation angle, which has the advantage of preventing unwanted accelerations and/or load peaks in the measurement. In addition, it is advantageously proposed in this context that the motor torque is increased continuously in both steering directions in the event that the steering mechanism is completely blocked in the test position, i.e. fixed and/or locked by means of the locking mechanism, for example, and in the event that the steering mechanism is not completely blocked in the test position, only in one steering direction up to the maximum motor torque.

Alternatively or additionally, it is proposed that the electric motor is actuated by means of the excitation signal such that dynamic excitation is achieved, wherein the electric motor is actuated with several different frequencies at several constant amplitudes. This allows a particularly precise evaluation to be achieved. In this case, a frequency pass or a frequency sweep is preferably used to actuate the electric motor, which is carried out for at least two different amplitudes of the motor torque. Particularly preferably, the frequency pass or the frequency sweep starts from high frequencies in the direction of lower frequencies. Advantageously, a maximum amplitude of the motor torque at the frequency pass or the frequency sweep is also below a maximum possible motor torque, i.e., at a maximum of 75% or at a maximum of 50% of the maximum possible motor torque, for example.

A particularly high level of operational reliability can be achieved in particular if at least one control parameter of a steering controller of the steering system, in particular for actuating the electric motor, is adapted on the basis of the determined the stiffness of the at least one steering assembly and/or play in the steering mechanism. In particular, stiffness-sensitive and/or play-sensitive control parameters can thereby be adjusted adaptively based on the determined stiffness and/or the determined play. In this case, the steering controller advantageously has an electrical connection to the computing unit and is particularly advantageously integrated into the control unit of the vehicle and/or the control unit of the steering system.

Furthermore, it is proposed that the stiffness of the at least one steering assembly and/or play in the steering mechanism is compared with a limit value, wherein in the event that the stiffness of the at least one steering assembly and/or play in the steering mechanism is below or exceeds the limit value, a safety measure is initiated. In particular, the safety measure can comprise at least the generation of a warning message in the vehicle and/or on an external electronic device, for example in the form of a smartphone, and/or the degradation of a driving mode, for example in the form of a reduction in the maximum vehicle speed. In particular, this can achieve a warning effect and further increase operational reliability.

In accordance with a further configuration, it is proposed that the stiffness of the at least one steering assembly and/or play in the steering mechanism is used to determine a moisture parameter. In particular, a “moisture parameter” should be understood as a parameter that can be used to infer moisture in the steering system or to determine moisture in the steering system. In this context, particular use is made of the fact that the stiffness of the at least one steering assembly and/or play in the steering mechanism changes depending on the moisture in the steering system. In particular, this can provide additional information about moisture in the steering system and/or determine correlated changes in the determined stiffness and/or play.

For example, the stiffness of the at least one steering assembly and/or play in the steering mechanism could be determined during a driving operation of the vehicle. Preferably, however, it is proposed that the stiffness of the at least one steering assembly and/or play in the steering mechanism is determined when the vehicle is stationary and/or the vehicle is parked, for example when the vehicle is temporarily stopped, such as at a traffic light, or when the vehicle is parked. This can advantageously reduce irritation of a driver and/or a passenger while driving.

Furthermore, it is proposed that the stiffness of the at least one steering assembly and/or play in the steering mechanics is determined at regular intervals, for example, at each system start-up, each system shutdown, or annually or biannually, as in particular in a vehicle inspection and/or customer service appointment, to monitor a change in the stiffness of the at least one steering assembly and/or a change in play in the steering mechanism. In particular, changes in the stiffness of the at least one steering assembly and/or play in the steering mechanic can thereby be detected advantageously quickly and an operational safety of the vehicle can be further increased.

According to one configuration, it is proposed that the steering mechanism comprises at least one steering assembly in the form of a servo train, wherein, in order to determine the stiffness of the servo train and/or play in the steering mechanism, a steering regulator element of the servo train, for example in the form of a gear rack, is positioned in the region of a mechanical end stop of the steering system, and the electric motor is actuated by means of the excitation signal such that the motor torque is continuously increased in the direction of the mechanical end stop up to the maximum motor torque. In this case, the position of the steering regulator element in the region of the mechanical end stop corresponds to the test position. Alternatively, however, the electric motor could also be actuated with several different frequencies at several constant amplitudes. In addition, the aforementioned process steps can be repeated in a further process step for at least one further test position that deviates from the test position. In this context, it is conceivable, for example, that in the further process step, in particular for determining the stiffness of the servo train, the steering regulator element is positioned in the region of a further mechanical end stop of the steering system, in particular opposite the mechanical end stop, and the electric motor is actuated by means of a further excitation signal, in particular equivalent to the excitation signal, such that the motor torque is continuously increased in the direction of the further mechanical end stop up to the maximum motor torque. Alternatively, however, the repetition in the further process step, in particular for determining play in the steering mechanism, can also relate to a further steering assembly that differs from the steering assembly. The stiffness of the servo string and/or play in the steering mechanism and in particular in the region of the servo train can thereby be determined in a particularly advantageous manner.

According to a further configuration, it is proposed that the steering mechanism comprises at least one steering assembly in the form of a sensor train, wherein, in order to determine the stiffness of the sensor train and/or play in the steering mechanism, the sensor train is blocked in a straight-ahead position, in particular mechanically, for example by actuating the locking mechanism, and the electric motor is actuated by means of the excitation signal such that the motor torque is continuously increased in both steering directions up to the maximum motor torque. In this case, the position of the sensor train in the straight-ahead position corresponds to the test position. Alternatively, however, the electric motor could also be actuated with several different frequencies at several constant amplitudes. In addition, the aforementioned process steps can, in principle, be repeated in a further process step for at least one further test position that deviates from the test position. In this case, however, it is advantageous not to repeat the method to determine the stiffness of the sensor train. To determine play in the steering mechanism, however, the repetition in the further method step can relate to a further steering assembly that deviates from the steering assembly. The stiffness of the sensor train and/or play in the steering mechanism and in particular in the region of the sensor train can thereby be determined in a particularly advantageous manner.

In addition, according to a further configuration, it is proposed that the steering mechanism comprises at least one steering assembly in the form of a vehicle axle or part of a vehicle axle, wherein, in order to determine the stiffness of the vehicle axle or the part of the vehicle axle and/or play in the steering mechanism, at least one vehicle wheel is blocked, in particular mechanically, for example by actuating the locking mechanism, and the electric motor is actuated by means of the excitation signal such that the motor torque is continuously increased in both steering directions up to the maximum motor torque. In this case, the position of the vehicle wheel in the blocked state corresponds to the test position. Alternatively, however, the electric motor could also be actuated with several different frequencies at several constant amplitudes. In addition, the aforementioned method steps can also be repeated in this case in a further process step for at least one further test position that deviates from the test position. In this context, it is conceivable, for example, that in the further process step, in particular for determining the stiffness of the vehicle axle or the part of the vehicle axle, at least one further vehicle wheel, in particular opposite the vehicle wheel, is blocked, in particular mechanically, for example by actuating the locking mechanism, and the electric motor is actuated by means of a further excitation signal, in particular equivalent to the excitation signal, such that the motor torque is continuously increased in both steering directions up to the maximum motor torque. Alternatively, however, the repetition in the further process step, in particular for determining play in the steering mechanism, can also relate to a further steering assembly that differs from the steering assembly. This is a particularly advantageous way of determining the stiffness of the vehicle axle or the part of the vehicle axle and/or play in the steering mechanism, especially in the area of the vehicle axle or the part of the vehicle axle.

The method for operating the steering system is not intended to be limited to the application and embodiment described hereinabove. In particular, the method for operating the steering system in order to achieve the functioning described herein can comprise a number of individual elements, components, and units that differs from the number specified herein.

### DRAWINGS

Further advantages follow from the description of the drawings hereinafter. The drawings show an embodiment example of the invention.

Shown are:

FIG. 1a-b a simplified representation of an exemplary vehicle with a steering system,

FIGS. 2a-b, exemplary diagrams of various signals for determining a stiffness of at least one steering assembly of a steering mechanism of the steering system and/or of play in the steering mechanism; and

FIG. 3 an exemplary flow chart with the main method steps of a method for operating the steering system.

### DESCRIPTION OF THE EMBODIMENT EXAMPLE

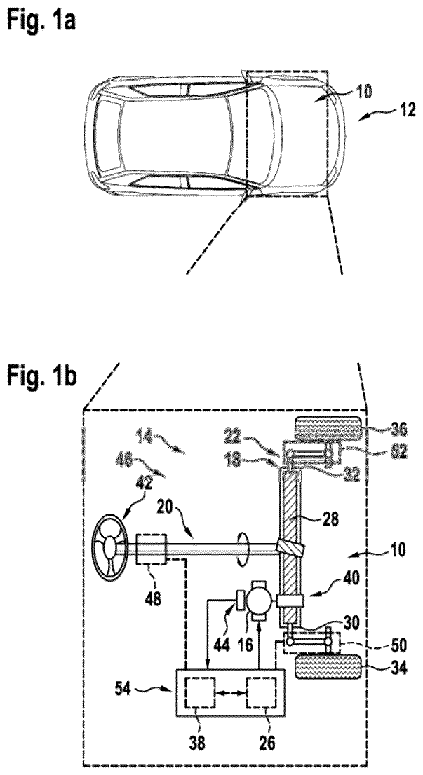

FIGS. 1a and 1b show an exemplary vehicle 12 designed as a motor vehicle with several vehicle wheels 34, 36 and with a steering system 10 in a simplified representation. The vehicle 12 is suitable for automated and/or autonomous driving. The steering system 10 is operatively connected to the vehicle wheels 34, 36, and is provided to influence a direction of travel of the vehicle 12. Furthermore, the steering system 10 is designed, purely by way of example, as an electrically assisted steering system and has an electric power assistance in the form of power steering. Alternatively, a steering system can also be designed as a steer-by-wire steering system as is known per se.

The steering system 10 comprises a steering mechanism 14 known per se and a steering actuator 40 cooperating with the steering mechanism 14 and known per se.

The steering mechanism 14 comprises a steering handle 42, in the present case exemplarily designed as a steering wheel, for applying a manual torque and several steering assemblies 18, 20, 22 operatively connected to the steering handle 42. In the present case, the steering mechanism 14 comprises a first steering assembly 18 designed as a servo train, a second steering assembly 20 designed as a sensor train and a third steering assembly 22 designed as a vehicle axle and/or part of a vehicle axle. The first steering assembly 18 corresponds to a steering gear, exemplarily designed as a rack-and-pinion steering gear, and comprises at least one steering regulator element 28, in particular designed as a gear rack in the present case. The first steering assembly 18 is intended to convert a steering input at the steering handle 42 into a steering movement of the vehicle wheels 34, 36, in particular designed as front wheels. The second steering assembly 20 corresponds in the present case to a steering shaft and serves to connect, in particular mechanically, the steering handle 42 to the first steering assembly 18. The third steering assembly 22 can comprise at least a part of the tie rods, which are assigned to the vehicle wheels 34, 36, and/or a part of the rims of the vehicle wheels 34, 36. Alternatively, a steering handle could also be designed as a steering lever and/or steering ball or similar. It is also conceivable to dispense with a steering shaft and/or a steering handle, such as in a steer-by-wire steering system.

The steering actuator 40 comprises an electric motor 16 and has an operative connection with the first steering assembly 18, in particular the steering regulator element 28. The steering actuator 40 is intended to provide a steering torque by means of the electric motor 16. In the present case, the steering actuator 40 is at least intended to provide a steering torque in the form of a support torque and to transmit it to the steering regulator element 28.

Furthermore, the steering system 10 has a rotor orientation sensor system 44 arranged in the region of the steering actuator 40. The rotor orientation sensor system 44 is provided for contactless detection of at least one operating signal of the electric motor 16 in particular in the present case a rotor orientation signal or a rotor orientation angle.

In addition, the steering system 10 has a locking mechanism 46, which is provided for blocking, in particular for fixing and/or locking, the steering mechanism 14. For this purpose, the locking mechanism 46 in the present case comprises several electrically and/or mechanically designed locks, in particular a steering lock 48 in the region of the steering handle 42, a first wheel lock 50 in the region of a first vehicle wheel 34 of the vehicle wheels 34, 36 and a second wheel lock 52 in the region of a second vehicle wheel 36 of the vehicle wheels 34, 36. However, it is also conceivable in principle to dispense with such a locking mechanism.

The vehicle 12 further comprises a control device 54. The control unit 54 is designed as a steering control unit and is therefore part of the steering system 10. The control unit 54 has an electrical connection with the steering actuator 40, in particular the electric motor 16. Furthermore, the control unit 54 has an electrical connection with the rotor orientation sensor system 44. Furthermore, the control unit 54 has an electrical connection with the locking mechanism 46. The control unit 54 is intended to control the operation of the steering system 10. In the present case, the control unit 54 is at least intended to actuate the electric motor 16. Alternatively, a control unit could also be different from a steering control unit and, for example, be designed directly as a central vehicle control unit.

The control unit 54 comprises a computing unit 38. The computing unit 38 comprises at least one processor (not depicted), e.g. in the form of a microprocessor, and at least one operating memory (not depicted). In addition, the computing unit 38 comprises at least one operating program stored in the operating memory.

Furthermore, the control unit 54 comprises a steering controller 26 known per se for actuating the electric motor 16. The steering controller 26 has an electrical connection with the computing unit 38. In addition, the steering controller 26 is electrically connected to the electric motor 16. In the present case, the steering controller 26 is provided at least in a driving mode of the vehicle 12 for controlling a position of the steering regulator element 28 and thus, in particular, a direction of travel of the vehicle 12.

Normally, only a very small proportion of the mechanical anomalies that can occur during operation of the vehicle 12 or the steering system 10 are detected automatically, while a large proportion of the anomalies must be detected by the driver himself. However, this fact can increasingly lead to problems in the future, particularly with automated and/or autonomously driving vehicles and/or steering systems in the form of steer-by-wire steering systems. The determination of a stiffness of the steering assemblies 18, 20, 22 of the steering mechanism 14 and/or of play in the steering mechanism 14 plays a significant role here, as signs of wear and/or aging effects can have a particularly critical effect here.

To increase efficiency and/or operational safety, a corresponding method for operating the steering system 10 is therefore proposed below. In the present case, the computing unit 38 is provided to perform the method and comprises a computer program with corresponding program code means for this purpose.

In the present case, to determine the stiffness of at least one steering assembly 18, 20, 22 and/or of play in the steering mechanism 14, the steering mechanism 14 is first brought into a defined test position and/or blocked in the test position. Preferably, the stiffness of the at least one steering assembly 18, 20, 22 and/or play in the steering mechanism 14 is determined when the vehicle 12 is stationary and/or when the vehicle 12 is parked. In addition, the positioning of the steering mechanism 14 in the test position can be performed manually, for example by an occupant and/or driver of the vehicle 12, or preferably automatically and/or in an automated manner by actuating the electric motor 16 accordingly. Blocking of the steering mechanism 14 in the test position can furthermore be performed by automated actuating of the locking mechanism 46.

The electric motor 16 is then actuated with an excitation signal. The electric motor 16 can generally be actuated with the driving signal in two different ways.

On the one hand, the electric motor 16 can be actuated by means of the excitation signal such that a quasi-static excitation is achieved, wherein a motor torque of the electric motor 16 is continuously increased up to a maximum motor torque, for example +5 Nm. In this case, the electric motor 16 is actuated by means of a ramped signal, so that the excitation signal is increased continuously and/or ramped. In addition, the motor torque is advantageously increased by adjusting the rotor orientation angle of the electric motor 16, which can prevent unwanted accelerations and/or load peaks in the measurement. In addition, if the steering mechanism 14 is completely blocked in the test position, the motor torque is continuously increased in both steering directions and if the steering mechanism 14 is not completely blocked in the test position, the motor torque is only continuously increased in one steering direction up to the maximum motor torque.

Alternatively or additionally, for example in a further application case, the electric motor 16 is actuated by means of the excitation signal such that dynamic excitation is achieved, wherein the electric motor 16 is actuated with several different frequencies at several constant amplitudes. In this case, a frequency pass or a frequency sweep is used to actuate the electric motor 16, which is carried out for at least two different amplitudes of the motor torque. Advantageously, the frequency pass or the frequency beep is starting from high frequencies in the direction of lower frequencies, for example starting from a frequency of 100 Hz in the direction of 0 Hz or from a frequency of 40 Hz in the direction of 0 Hz. Advantageously, a maximum amplitude of the motor torque at the frequency pass or the frequency sweep is also below a maximum possible motor torque, i.e., at a maximum of 75% or at a maximum of 50% of the maximum possible motor torque, for example. In this context, for example, amplitudes of 0.2 Nm and 0.5 Nm have proven suitable. By positioning and/or blocking the at least one steering assembly 18, 20, 22 in the test position, it is possible in this case to determine the stiffness of the at least one steering assembly 18, 20, 22 and/or play in the steering mechanism 14 in both a low-load range and a high-load range.

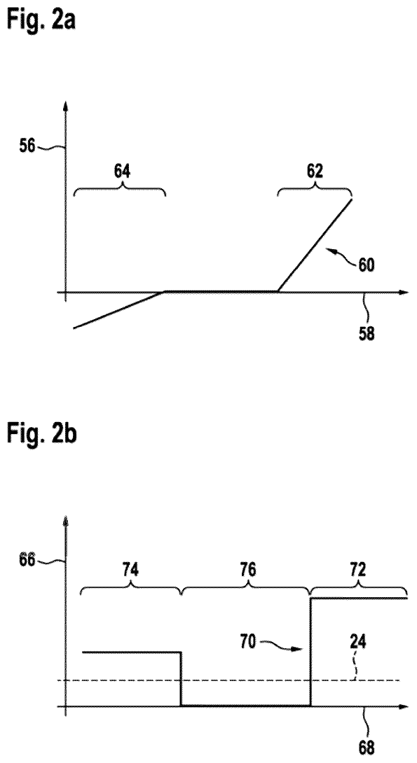

The stiffness of the at least one steering assembly 18, 20, 22 and/or play in the steering mechanism 14 is then determined by monitoring a motor torque of the electric motor 16 and a rotor orientation angle of the electric motor 16 during actuation of the electric motor 16 with the excitation signal and evaluating a change in the motor torque according to the rotor orientation angle. The motor torque of the electric motor 16 can, for example, be read out directly from the control unit 54 or detected by means of an additional detection sensor system, while the rotor orientation angle of the electric motor 16 can advantageously be determined from the rotor orientation signal of the rotor orientation sensor system 44. In the present case, a derivative of the motor torque according to the rotor orientation angle or a difference quotient of motor torque and rotor orientation angle is formed and compared with a reference value 24 to determine the stiffness of the at least one steering assembly 18, 20, 22 and/or play in the steering mechanism 14 (see also FIG. 2b).

Advantageously, linearization can further be used in determining the stiffness of the at least one steering assembly 18, 20, 22, and/or play in steering mechanism 14. In this context, it must be taken into account that the stiffness to be determined and/or play to be determined normally has a non-linear relationship. In the present case, however, it was recognized that even when using a corresponding linearization, relatively precise and exact statements about the stiffness of the at least one steering assembly 18, 20, 22 and/or play of the steering mechanism 14 are possible and at the same time a computational effort can be greatly reduced.

To improve the accuracy of the measurement, a current temperature can also be considered when determining the stiffness of the at least one steering assembly 18, 20, 22, and/or play in the steering mechanism 14. In this context, particular use is made of the fact that the stiffness of the at least one steering assembly 18, 20, 22 and/or play in the steering mechanism 14 changes depending on the current temperature. Preferably, the temperature is detected directly in the region of the electric motor 16, in particular by means of a temperature sensor system integrated into the steering actuator 40. Alternatively, however, additional temperature sensors could also be used in the region of the electric motor 16 or in the region of the steering mechanism 14. Furthermore, existing temperature sensors in the vehicle 12, for example for displaying an outside temperature, could also be used to determine a temperature. It is also conceivable to completely dispense with the additional determination of a temperature.

After determining the stiffness of the at least one steering assembly 18, 20, 22, and/or play in the steering mechanism 14, various actions can then be performed and/or triggered depending on the determined values.

For example, using the determined stiffness of the at least one steering assembly 18, 20, 22 and/or the determined play in the steering mechanism 14, at least one control parameter of the steering controller 26 can be adjusted, whereby advantageously stiffness-sensitive and/or play-sensitive control parameters can be adjusted adaptively based on the determined stiffness and/or the determined play.

Furthermore, the stiffness of the at least one steering assembly 18, 20, 22 and/or play in the steering mechanism 14 can be compared with a limit value, wherein in the event that the stiffness and/or play is below or exceeds the limit value, a safety measure is initiated. The safety measure can comprise at least the generation of a notification message in the vehicle and/or on an external electronic device, for example in the form of a notification of a workshop visit, and/or a degradation of a driving mode, for example in the form of a reduction of a maximum vehicle speed.

Furthermore, the stiffness of the at least one steering assembly 18, 20, 22, and/or play in the steering mechanism 14 can be used to determine a moisture parameter, wherein the moisture parameter can be used to infer moisture in the steering system 10 or to determine moisture in the steering system 10. This can provide additional information about a moisture in the steering system 10 and/or determine correlated changes in the determined stiffness and/or play.

In the present case, it is proposed that the stiffness of the at least one steering assembly 18, 20, 22 and/or play in the steering mechanism 14 is determined at regular intervals, for example at each system start-up or each system shutdown, to monitor a change in the stiffness of the at least one steering assembly 18, 20, 22 and/or a change in play in the steering mechanism 14. Changes in the stiffness of the at least one steering assembly 18, 20, 22 and/or play in the steering mechanism 14 can thereby be detected advantageously quickly and an operational safety of the vehicle 12 can be further increased. Alternatively, however, it is also conceivable to provide a longer monitoring interval, such as daily, monthly or annually.

In the following, several specific cases of application of the general facts explained above are now described for the first steering assembly 18 designed as a servo train, the second steering assembly 20 designed as a sensor train and the third steering assembly 22 designed as a vehicle axle and/or part of a vehicle axle.

According to a first aspect, in order to determine the stiffness of the first steering assembly 18 or the servo train, the steering regulator element 28 is positioned in the region of a mechanical end stop 30 of the steering system 10 and the electric motor 16 is actuated by means of the excitation signal such that the motor torque is continuously increased in the direction of the mechanical end stop 30 up to the maximum motor torque. In this case, the position of the steering regulator element 28 in the region of the mechanical end stop 30 corresponds to the test position. To position the steering regulator element 28 in the test position, the steering regulator element 28 can, for example, be positioned directly in the region of the mechanical end stop 30 by actuating the electric motor 16 and by means of an appropriately taught software function, or it can be moved at a constant movement speed (approx. 10 mm/s to 40 mm/s) in the direction of the mechanical end stop 30 until the test position is reached or the test position is detected by means of a decreasing movement speed. Using the motor torque of the electric motor 16 and the rotor orientation angle of the electric motor 16, the total stiffness of the servo train and mechanical end stop 30 can then be determined for the corresponding load direction, i.e. in the direction of the mechanical end stop 30. The following applies:

$$\frac{1}{{c}_{1}} = \frac{1}{{c}_{Servo}} + \frac{1}{{c}_{A}} \qquad ( 1 )$$

c₁ describes the total stiffness of the servo train and mechanical end stop 30 for the corresponding load direction, c_{Servo} describes the stiffness of the first steering assembly 18 or the servo train and c_{A} describes the stiffness of the mechanical end stop 30. Now that the stiffness of the mechanical end stop 30 is known, the stiffness of the first steering assembly 18 or the servo train can be deduced using equation (1). In particular, when an end stop damper is used, the stiffness of the mechanical end stop 30 is dominated by the proportion of the end stop damper. Alternatively, however, in this case the electric motor could also be actuated with several different frequencies at several constant amplitudes.

The aforementioned process steps can then be repeated for the opposite side. In this case, the steering regulator element 28 is positioned in the region of a further mechanical end stop 32 of the steering system, in particular opposite the mechanical end stop 30, and the electric motor 16 is actuated by means of a further excitation signal, in particular equivalent to the excitation signal, such that the motor torque is continuously increased in the direction of the further mechanical end stop 32 up to the maximum motor torque. In this case, the position of the steering regulator element 28 in the region of the further mechanical end stop 32 thus corresponds to a further test position. Positioning of the steering regulator element 28 in the further test position and evaluation of the stiffness can be carried out using the method described above.

According to a second aspect, in order to determine the stiffness of the second steering assembly 20 or the sensor train, the sensor train is blocked in a straight-ahead position, in particular by actuating the locking mechanism 46 or, more precisely, the steering lock 48, and the electric motor 16 is actuated by means of the excitation signal such that the motor torque is continuously increased in both steering directions up to the maximum motor torque. In this case, the position of the sensor train in the straight-ahead position thus corresponds to the test position. The sensor train can be positioned in the straight-ahead position manually or preferably by actuating the electric motor 16 and the locking mechanism 46 accordingly. The total stiffness of the sensor train and servo train can then be determined based on the motor torque of the electric motor 16 and the rotor orientation angle of the electric motor 16. The following applies:

$$\frac{1}{{c}_{2}} = \frac{1}{{c}_{Sensor}} + \frac{1}{{c}_{Servo}} \qquad ( 2 )$$

c₂ describes the total stiffness of the sensor train and servo train, c_{Sensor} describes the stiffness of the second steering assembly 20 or the sensor train and c_{Servo} describes the stiffness of the first steering assembly 18 or the servo train. If the stiffness of the first steering assembly 18 or the servo train has been determined as described above and is therefore known, the stiffness of the second steering assembly 20 or the sensor train can be deduced from equation (2). Alternatively, however, in this case the electric motor could also be actuated with several different frequencies at several constant amplitudes. In this case, it is not necessary to repeat the process steps, as the excitation takes place in both steering directions, as described above.

According to a third aspect, in order to determine the stiffness of the third steering assembly 22 or the vehicle axle or the part of the vehicle axle, one of the vehicle wheels 34, 36 is blocked, in particular by actuating the locking mechanism 46 or, more precisely, the wheel lock 50 or the wheel lock 52, and the electric motor 16 is actuated by means of the excitation signal such that the motor torque is continuously increased in both steering directions up to the maximum motor torque. In this case, the other of the vehicle wheels 34, 36 is in a freely rotating state, such as on a lifting platform. In this case, the position of the vehicle wheel 34, 36 in the locked state thus corresponds to the test position. Based on the motor torque of the electric motor 16 and the rotor orientation angle of the electric motor 16, the total stiffness of the vehicle axle and servo train can then be determined. The following applies:

$$\frac{1}{{c}_{3}} = \frac{1}{{c}_{FZ}} + \frac{1}{{c}_{Servo}} \qquad ( 3 )$$

c₃ describes the total stiffness of the vehicle axle and servo train, C_{FZ} describes the stiffness of the third steering assembly 22 or the vehicle axle or part of the vehicle axle and c_{Servo} describes the stiffness of the first steering assembly 18 or the servo train. If the stiffness of the first steering assembly 18 or the servo train has been determined as described above and is therefore known, the stiffness of the third steering assembly 22 or the vehicle axle or part of the vehicle axle can be deduced using equation (3). Alternatively, however, in this case the electric motor could also be actuated with several different frequencies at several constant amplitudes.

The aforementioned process steps can then be repeated for the opposite side. The other of the vehicle wheels 34, 36 is blocked and the electric motor 16 is actuated by means of a further excitation signal, in particular one equivalent to the excitation signal, such that the motor torque is continuously increased in both steering directions up to the maximum motor torque. The stiffness can again be evaluated using the method described above.

To determine the play in steering mechanics 14, According to a fourth aspect, at least two of the previously mentioned methods for determining the stiffness can be combined with one another.

According to one variant, in order to determine the play in the steering mechanism 14, in particular between the first steering assembly 18 and the second steering assembly 20, the stiffness of the first steering assembly 18 or the servo string is determined using the aforementioned first method and the stiffness of the second steering assembly 20 or the sensor string is determined using the aforementioned second method. The total play of the servo train and sensor train can then be determined based on the motor torque of the electric motor 16 and the rotor orientation angle of the electric motor 16. The following applies:

$${Δφ}_{1} = {Δφ}_{Servo} + {Δφ}_{Sensor} \qquad ( 4 )$$

Δφ₁ describes the total play of the servo train and sensor train, Δφ_{Servo} describes the play in the area of the first steering assembly 18 or the servo train and Δφ_{Sensor} describes the play in the area of the second steering assembly 20 or the sensor train. In this case, it is also not necessary to distinguish between Δφ_{Servo} and Δφ_{Sensor} because if a corresponding limit value is exceeded, a workshop should be visited anyway. The cause can then be finally narrowed down. A repeat of the method steps is also not necessary in this case.

According to a further variant, in order to determine the play in the steering mechanism 14, in particular between the first steering assembly 18 and the third steering assembly 22, the stiffness of the first steering assembly 18 or the servo string is determined using the aforementioned first method and the stiffness of the third steering assembly 22 or the vehicle axle or the part of the vehicle axle is determined using the aforementioned third method. Based on the motor torque of the electric motor 16 and the rotor orientation angle of the electric motor 16, the total play of the servo train and vehicle axle can then be determined. The following applies:

$${Δφ}_{2} = {Δφ}_{Servo} + {Δφ}_{FZ} \qquad ( 5 )$$

Δφ₂ describes the total play of the servo train and vehicle axle, Δφ_{Servo} describes the play in the area of the first steering assembly 18 or the servo train and Δφ_{FZ} describes the play in the area of the third steering assembly 22 or the vehicle axle or the part of the vehicle axle. In this case, it is not necessary to distinguish between Δφ_{Servo} and Δφ_{FZ} because if a corresponding limit value is exceeded, a workshop should be visited anyway. The cause can then be finally narrowed down. A repeat of the method steps is also not necessary in this case.

Furthermore, by combining all of the aforementioned methods, the total play of the servo train, vehicle axle and sensor train can generally also be determined.

FIGS. 2a and 2b show exemplary diagrams of various signals for determining a stiffness of at least one steering assembly 18, 20, 22 and/or of the play in the steering mechanism 14. The example shown in FIGS. 2a and 2b is limited to the first steering assembly 18 and the third steering assembly 22.

In FIG. 2a, the motor torque of the electric motor 16 is plotted on an ordinate axis 56. The rotor orientation angle of the electric motor 16 is shown on an abscissa axis 58. Curve 60 shows a curve, in particular a linearized curve, of the motor torque as a function of the rotor orientation angle.

A first region 62 schematically shows an exemplary course of the motor torque according to the rotor position angle for determining the stiffness in the region of the first steering assembly 18 or the servo train.

A second region 64 schematically shows an exemplary course of the motor torque according to the rotor orientation angle for determining the stiffness in the region of the third steering assembly 22 or the vehicle axle or the part of the vehicle axle.

In FIG. 2b, a stiffness is plotted on a further ordinate axis 66. The rotor orientation angle of the electric motor 16 is again shown on a further abscissa axis 68. A curve 70 shows a course of the stiffness according to the rotor orientation angle. To determine the curve 70, a derivative of the motor torque according to the rotor position angle or a difference quotient of motor torque and rotor position angle is formed.

In this case, a first region 72 schematically shows an exemplary curve of the total stiffness of the servo train and mechanical end stop 30 for the corresponding load direction, i.e. in the direction of the mechanical end stop 30.

A second region 74 schematically shows an exemplary curve of total stiffness of the vehicle axle, servo string, and drill friction between a tire support surface and a subsurface.

A third region 76 further indicates the play in the steering mechanism 14, particularly between the first steering assembly 18 and the third steering assembly 22.

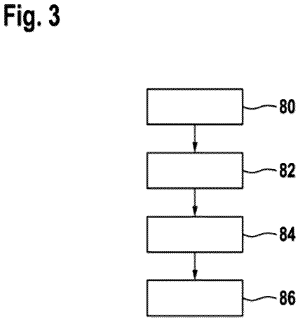

Finally, FIG. 3 shows an exemplary flow chart with the main method steps of a method for operating the steering system 10.

In a process step 80, the steering mechanism 14 is positioned and/or blocked in a corresponding test position. In this context, the positioning of the steering mechanism 14 in the test position can be performed manually, for example by an occupant and/or driver of the vehicle 12, or preferably automatically and/or automatically by actuating the electric motor 16 accordingly.

In a subsequent method step 82, the steering system 10 is excited by actuating the electric motor 16 with the excitation signal, namely while the steering mechanism 14 is in the test position. The electric motor 16 can be actuated by means of the excitation signal such that a quasi-static excitation and/or dynamic excitation is achieved.

In a subsequent method step 84, a system response of the steering system 10 to the excitation signal is determined and evaluated using the motor torque of the electric motor 16 and the rotor orientation angle of the electric motor 16, in particular by means of a derivative of the motor torque according to the rotor orientation angle or a difference quotient of motor torque and rotor orientation angle. The system response can then be utilized to determine a stiffness of at least one steering assembly 18, 20, 22 of the steering mechanism 14 and/or of the play in the steering mechanism 14.

In a subsequent process step 86, various actions can then be carried out and/or triggered depending on the stiffness values and/or play values determined, such as, for example, adjusting at least one control parameter of the steering controller 26 and/or initiating a safety measure if the limit value is exceeded or not reached.

The exemplary flow chart in FIG. 3 is only intended to describe an exemplary method for operating the steering system 10. In particular, individual method steps can also vary, or additional method steps can be added. For example, the method steps 80, 82 and 84 can be repeated in a method step immediately following the method step 84 for at least one further test position deviating from the test position. In particular, the repetition can concern the same steering assembly 18, 20, 22 or one of the other steering assemblies 18, 20, 22.

1. A method for operating a steering system of a vehicle, wherein the steering system comprises a steering mechanism and an electric motor cooperating with the steering mechanism, and wherein a stiffness of at least one steering assembly of the steering mechanism and/or play in the steering mechanism is determined, comprising:
bringing the steering mechanism into a defined test position and/or blocking the steering mechanism in the test position;
actuating the electric motor with an excitation signal; and
determining the stiffness of the at least one steering assembly and/or play in the steering mechanism during the actuation of the electric motor with the excitation signal by monitoring a motor torque of the electric motor and a rotor orientation angle of the electric motor and evaluating a change in the motor torque according to the rotor orientation angle.

2. The method according to claim 1, wherein the stiffness of the at least one steering assembly and/or play in the steering mechanism is determined by a derivation of the motor torque according to the rotor orientation angle or a difference quotient of the motor torque and the rotor orientation angle.

3. The method according to claim 1, wherein to determine the stiffness of the at least one steering assembly and/or play in the steering mechanism, the change in the motor torque according to the rotor orientation angle is compared with a reference value.

4. The method according to claim 1, wherein linearization is used in determining the stiffness of the at least one steering assembly and/or play in the steering mechanism.

5. The method according to claim 1, wherein a current temperature is considered in determining the stiffness of the at least one steering assembly and/or play in the steering mechanism.

6. The method according to claim 1, wherein:
the electric motor in a first application case is actuated by the excitation signal such that a quasi-static excitation is achieved; and
the motor torque is continuously increased up to a maximum motor torque.

7. The method according to claim 6, wherein:
the motor torque is continuously increased in both steering directions with the steering mechanism blocked in the test position; or
the motor torque is continuously increased in one steering direction up to the maximum motor torque with the steering mechanism not blocked in the test position.

8. The method according to claim 1, wherein:
the electric motor in a second application case, is actuated by the excitation signal such that dynamic excitation is achieved; and
the electric motor is actuated with several different frequencies at several constant amplitudes.

9. The method according to claim 1, wherein at least one control parameter of a steering controller, of the steering system, configured to actuate the electric motor is adjusted based on the determined stiffness of the at least one steering assembly and/or the determined play in the steering mechanism.

10. The method according to claim 1, wherein:
the stiffness of the at least one steering assembly and/or play in the steering mechanism is compared with a limit value; and
a safety measure is initiated in response to the stiffness of the at least one steering assembly and/or play in the steering mechanism being below or exceeding the limit value.

11. The method according to claim 1, wherein the stiffness of the at least one steering assembly and/or play in the steering mechanism is used to determine a moisture parameter.

12. The method according to claim 1, wherein the stiffness of the at least one steering assembly and/or play in the steering mechanism is determined when the vehicle is stationary and/or when the vehicle is parked.

13. The method according to claim 1, wherein the stiffness of the at least one steering assembly and/or play in the steering mechanism is determined at regular intervals to monitor a change in the stiffness of the at least one steering assembly and/or a change in the play in the steering mechanism.

14. The method according to claim 1, wherein:
the steering mechanism comprises at least one steering assembly in the form of a servo train; and
a steering regulator element of the servo train is positioned in a region of a mechanical end stop of the steering system, and the electric motor is actuated by the excitation signal such that the motor torque is continuously increased in a direction of the mechanical end stop up to a maximum motor torque to determine the stiffness of the servo train and/or play in the steering mechanism.

15. The method according to claim 1, wherein:
the steering mechanism comprises at least one steering assembly in the form of a sensor train; and
the sensor train is blocked in a straight-ahead position, and the electric motor is actuated by the excitation signal such that the motor torque is continuously increased in both steering directions up to a maximum motor torque to determine the stiffness of the sensor train and/or play in the steering mechanism.

16. The method according to claim 1, wherein:
the steering mechanism comprises at least one steering assembly in the form of a vehicle axle or part of a vehicle axle; and
at least one vehicle wheel is blocked, and the electric motor is actuated by the excitation signal such that the motor torque is continuously increased in both steering directions up to a maximum motor torque to determine the stiffness of the vehicle axle or the part of the vehicle axle and/or play in the steering mechanism.

17. A computing unit configured to perform the method according to claim 1.

18. A steering system with a steering mechanism, with the electric motor cooperating with the steering mechanism and with the computing unit according to claim 17.

19. A motor vehicle, with the steering system according to claim 18.
